(19) United States
(12) Patent Application Publication
(10) Pub. No.: US 2015/0288855 A1
(43) Pub. Date: Oct. 8, 2015

(54) PROVIDING INFORMATION ABOUT A PROCESS EXECUTED ON AN IMAGE PROCESSING DEVICE

(71) Applicants: Canon Information and Imaging Solutions, Inc., Melville, NY (US); Canon U.S.A., Inc., Melville, NY (US)

(72) Inventors: Jiuyuan Ge, Centereach, NY (US); Nigel Patrick Brady, Irvine, CA (US); Song Sheng Cang, Jericho, NY (US); Lance Yiuchong Leung, New York, NY (US); Kosuke Nakashima, Great Neck, NY (US); Konstantin Uroskin, New York, NY (US)

(21) Appl. No.: 14/680,634

(22) Filed: Apr. 7, 2015

Related U.S. Application Data
(60) Provisional application No. 61/977,076, filed on Apr. 8, 2014.

(51) Int. Cl. H04N 1/44; G06F 21/62

(52) U.S. Cl. CPC H04N 1/4413; G06F 21/629

(57) ABSTRACT

Methods, systems, and computer-readable media are provided. Some embodiments include performing a login process wherein access to one or more resources on an image processing device is granted based on a credential associated with a user. A scan and send process is requested and initiated. A log out command is received during execution of the scan and send process and it is determined that execution of the process is in progress. A log out process that enables execution of the scan and send process to continue is performed. Data associated with the scan and send process is stored when execution of the scan and send process has terminated. The credential and an access request is received at the image processing device. Information about the scan and send process is presented on a display of the image processing device based on the data associated with the scan and send process.

### CROSS-REFERENCE TO RELATED APPLICATIONS

This application claims the benefit of U.S. Provisional Application No. 61/977,076, filed Apr. 8, 2014, which is hereby incorporated by reference herein in its entirety.

### BACKGROUND OF THE INVENTION

1. Field of the Invention

The present invention relates generally to managing information about a process, and more particularly to providing information about a process executed on an image processing device.

2. Description of the Related Art

Modern computing systems often employ security measures to prevent breaches of the computing system. For example, computing systems may require users to be authenticated before granting them access to one or more resources of the computing system. Authentication may include the computing system prompting the user to provide a credential in order to log in to the computing system. The authentication may be based on a username and password, a smart card, a personal identification number (PIN), biometric information, other information associated with the user, or a combination of two or more of these. Once logged in to the computing system, the user has access to one or more resources of the computing system.

Computing devices and software applications may employ authentication mechanisms to control access to protected resources. A user may be required to log in to a computing device and/or an application executing on a computing device in order to obtain information or utilize a feature of the computing device and/or application. For example, an application executing on a computing device may provide functionality enabling a logged-in user to perform one or more tasks. When a user is logged out of the computing device and/or application, the user has no access or limited access to particular functionality and information of the computing device and/or application.

Image processing devices may employ authentication mechanisms to control access to resources on the image processing device. For example, a multifunction peripheral, copier, scanner, printer, or other image processing device, may require users to be authenticated before granting them access to one or more resources of the image processing device. Additionally or alternatively, an application executing on the image processing device may require users to be authenticated before granting them access to one or more resources of the application or image processing device. Once logged in to the image processing device and/or application, the user may be permitted to utilize various functions, features, and user interfaces in order to perform particular tasks. By way of example, the image processing device and/or application executing on the image processing device may provide functionality for making photocopies, printing a document, scanning a document and generating an electronic document representing the scanned document, transmitting data over a network, accessing a database on a remote server, or other task. When logged out of the image processing device and/or application, the user may have no access or limited access to functionality and information of the image processing device and/or application.

### BRIEF SUMMARY OF THE INVENTION

Methods, systems, and computer-readable media for providing information about a process executed on an image processing device are disclosed.

Some embodiments of the invention include performing, at an image processing device, a login process wherein access to one or more resources on the image processing device is granted based on a credential associated with a user. A request to perform a scan and send process is received at the image processing device, the request comprising instructions for scanning a physical document and sending an electronic document representing the scanned physical document to a destination. The scan and send process is initiated. A log out command is received at the image processing device during execution of the scan and send process. It is determined that execution of the scan and send process is in progress. A log out process that enables execution of the scan and send process to continue is performed. When execution of the scan and send process has terminated, data associated with the scan and send process is stored in a data structure. Subsequently, the credential associated with the user and a request to access one or more resources on the image processing device is received at the image processing device. Information about the scan and send process is presented on a display of the image processing device, the information about the scan and send process based on the data associated with the scan and send process that is stored in the data structure.

Further features of the present invention will become apparent from the following description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates an example network environment.

FIG. 2 illustrates an example flow of operations at an image processing device.

FIG. 3 illustrates an example data structure.

FIG. 4 illustrates an example flow of operations at an image processing device.

FIG. 5 illustrates an example data structure.

FIG. 6 illustrates an example graphical user interface on a display of an image processing device.

FIG. 7 illustrates an example data structure.

FIG. 8 illustrates an example graphical user interface on a display of an image processing device.

FIG. 9 illustrates an example data structure.

FIG. 10 illustrates an example data structure.

FIG. 11 illustrates an example graphical user interface on a display of an image processing device.

FIG. 12 illustrates an example image processing device.

FIG. 13 illustrates an example computing system.

### DETAILED DESCRIPTION OF THE INVENTION

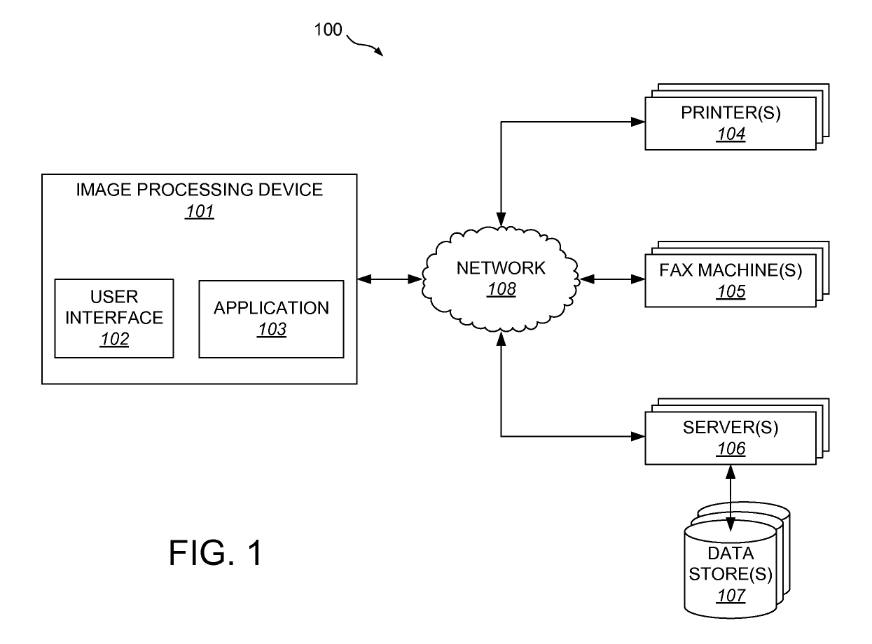

Embodiments of the present invention are described with reference to the drawings. FIG. 1 illustrates an example network environment 100. An image processing device 101 having a user interface 102 and an application 103, one or more printer(s) 104, one or more fax machine(s) 105, and one or more server(s) 106, which may each be coupled to one or more data store(s) 107, are connected to a network 108.

The image processing device 101 includes hardware, software, or both for providing the functionality of the image processing device 101. In some embodiments, the image processing device 101 performs one or more steps of one or more methods described or illustrated herein. In some embodiments, the image processing device 101 provides functionality described or illustrated herein. In some embodiments, software running on the image processing device 101 performs one or more steps of one or more methods described or illustrated herein or provides functionality described or illustrated herein. Particular embodiments include one or more portions of the image processing device 101.

In some embodiments, the image processing device 101 includes hardware, software, or both for providing scanning functionality. For example, the image processing device 101 may include an image sensor or a camera for capturing an image. In some embodiments, the image processing device 101 scans a physical document to generate electrical signals which are converted to digital image data representing the scanned physical document. The image processing device 101 may convert the digital image data into an electronic document representing the scanned physical document and send the electronic document to a destination.

The image processing device 101 includes the user interface 102. The user interface 102 includes hardware, software, or both for providing the functionality of the user interface 102. The user interface 102 may include an operation panel. The user interface 102 may output signals and receive input signals via the operation panel so as to facilitate interaction between a user and the image processing device 101. An operation panel may include a hard key panel and/or a touch sensitive display. A user may provide user input operations via the hard key panel and/or the touch sensitive display to control the image processing device 101 via the operation panel. For example, the user may press one or more hard buttons to issue one or more commands. Further by way of example, a user may provide a touch input to an interface element displayed on the display to issue a command and/or to make a selection. Moreover, the image processing device 101 may output information to the user and issue requests by outputting images on a display.

In some embodiments, a browser may execute on the image processing device 101. In some embodiments, the user interface 102 comprises information displayed by the browser. The browser may be a web browser such as MICROSOFT INTERNET EXPLORER or MOZILLA FIREFOX, and may be used to access a resource, such as a web page. The browser may enable a user to display and interact with text, images, form elements, or other information typically located on a web page served by a web server on the World Wide Web or a local area network. The browser may support various types of downloadable, executable, software modules, such as applets or plug-ins. For example, the browser may incorporate a virtual machine configured to execute a program, such as a JAVA applet, embedded in a web page accessed by the browser. The image processing device 101 may have various add-ons, plug-ins, or other extensions for use in or with the browser.

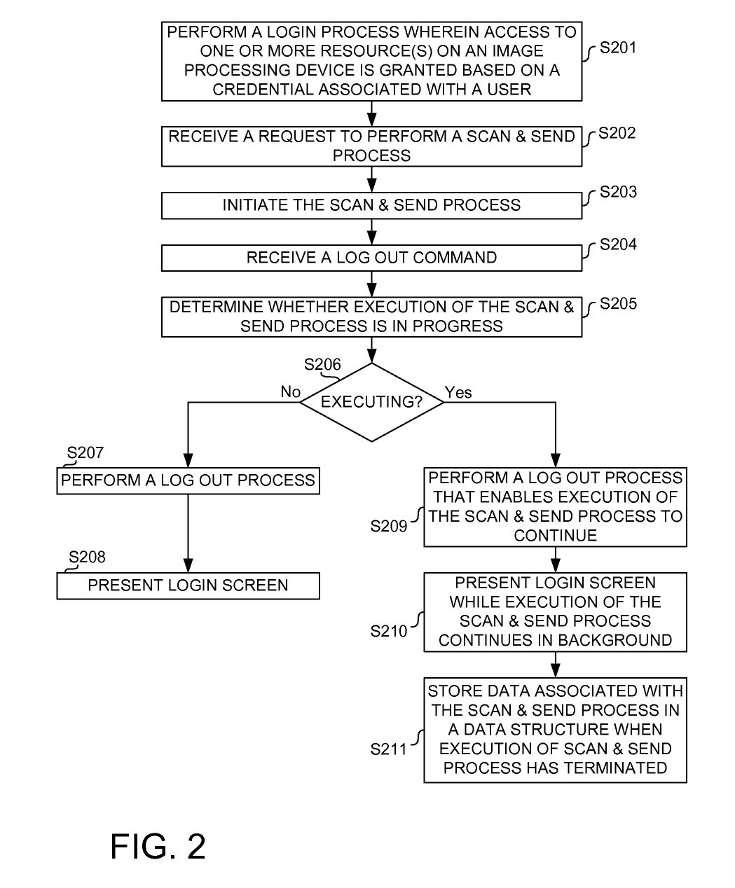

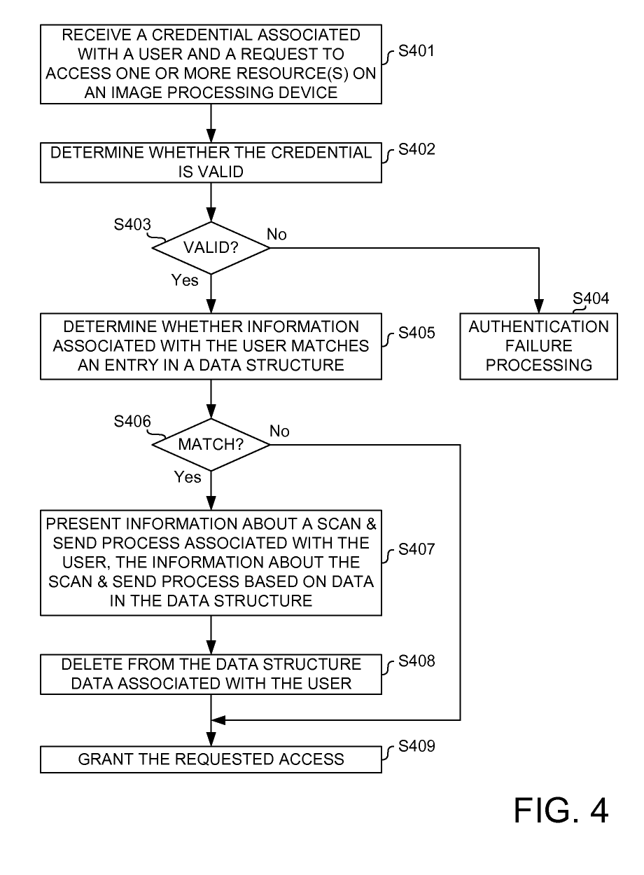

The application 103 includes programs and related data. In some embodiments, the application 103 executing on the image processing device 101 performs one or more steps of one or more methods described or illustrated herein or provides functionality described or illustrated herein. By way of example and not by way of limitation, programs of the application 103 may include instructions which, when executed by one or more processors, cause the one or more processors to perform one or more operations described with respect to FIG. 2 and/or FIG. 4.

In some embodiments, the application 103 includes one or more programs for controlling access to one or more resources on the image processing device 101. In some embodiments, the application 103 includes one or more programs for controlling access to the application 103 and/or particular functionality of the application 103. In some embodiments, access to one or more resources of the application 103 is controlled based on a credential associated with the entity attempting to access the one or more resources of the application 103. Policies for controlling access to various resources of the application 103 may be stored at the image processing device 101. In some embodiments, the application 103 includes one or more programs for accessing services, such as an authentication service. For example, the application 103 may cause the image processing device 101 to send to an authentication service on the network 108 a request to authenticate a user before the user is granted access to a resource of the image processing device 101 and/or the application 103.

Once logged in to the application 103, a user gains access to one or more resources of the application 103, including task-specific functionality of the application 103. The task-specific functionality of the application 103 may enable the user to perform one or more tasks using the application 103. For example, the application 103 may provide various functions, features and user interfaces for processing image data, transmitting data over a network, managing one or more databases, or other tasks. In some embodiments, the application 103 is configured to use one or more resources of the image processing device 101 to perform a process in response to an instruction from the user. For example, the application 103 may use functionality of and/or information on the image processing device 101 to carry out a scan and send process based on user inputs.

In some embodiments, the application 103 executing on the image processing device 101 provides functionality for maintaining and accessing information in a data structure, which may be any suitable data structure for organizing data. For example, information associated with a user or process may be added as one or more entries into a data structure. The application 103 executing on the image processing device 101 may store and/or retrieve data in a memory or on a hard disk of the image processing device 101. In some embodiments, the image processing device 101, when executing the application 103, may perform various operations with respect to a data store. Examples of operations include adding entries to a data store; deleting entries from a data store; modifying entries in a data store; searching for entries in a data store; and retrieving entries from a data store.

The application 103 executing on the image processing device 101 may provide functionality for generating information and providing the information to the user interface 102 of the image processing device 101. The information may include text, images, form elements, files, executable programs, or other suitable information. The information provided by the application 103 may include content for display on a display of the image processing device 101.

The image processing device 101 may access one or more resources on the network 108. The image processing device 101 is configured to interact with one or more of the following: the one or more printer(s) 104, the one or more fax machine(s) 105, and the one or more server(s) 106.

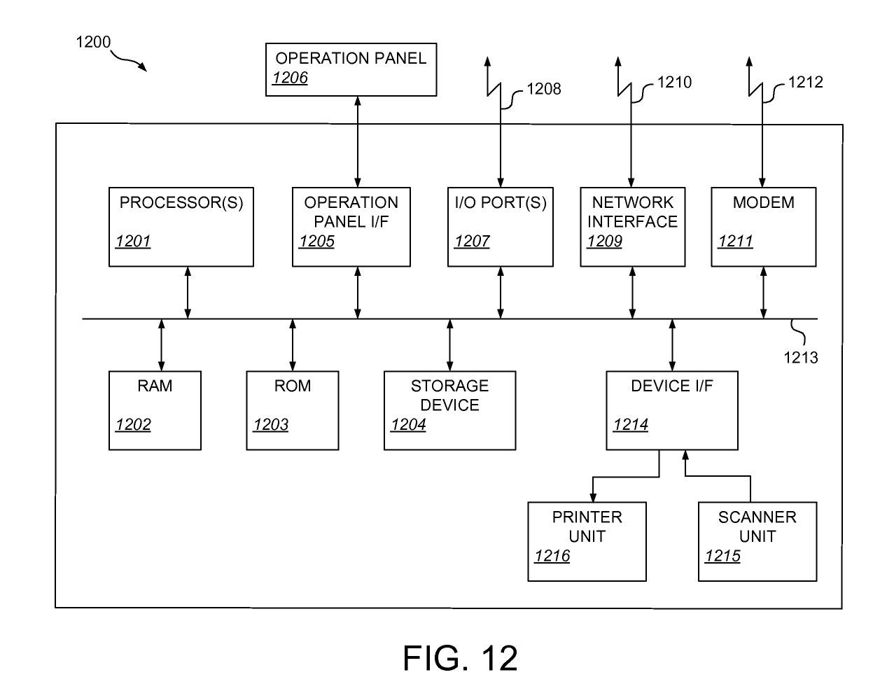

The one or more printer(s) 104 is/are any suitable device(s) for printing. The one or more printer(s) 104 may include one or more multifunction peripherals, one or more copiers, one or more single-function printers, or other device(s) with printing capabilities. In some embodiments, at least one of the one or more printer(s) 104 comprises an image processing device according to the example image processing device 1200 of FIG. 12. In some embodiments, at least one of the one or more printer(s) 104 is coupled to at least one of the one or more fax machine(s) 105 and may print data sent from the fax machine(s) 105 to the printer(s) 104.

The one or more fax machine(s) 105 is/are any suitable device(s) for sending and receiving a facsimile communication. In some embodiments, at least one of the one or more fax machine(s) 105 may receive a digital facsimile communication. In some embodiments, at least one of the one or more fax machine(s) 105 may receive an analog facsimile communication. The one or more fax machine(s) 105 may provide scanning functionality. For example, the one or more fax machine(s) 105 may include an image sensor or a camera for capturing an image. The one or more fax machine(s) 105 may scan a physical document to generate a facsimile communication representing the scanned physical document. In some embodiments, at least one of the one or more fax machine(s) 105 may generate an analog signal and send the analog signal to a destination. In some embodiments, at least one of the one or more fax machine(s) 105 scans a physical document to generate electrical signals which are converted to digital image data representing the scanned physical document. The digital image data may be converted into an electronic document representing the scanned physical document and sent to a destination.

At least one of the one or more fax machine(s) 105 is/are able to send and receive facsimile communications over the Public Switched Telephone Network (PSTN). At least one of the one or more fax machine(s) 105 is/are able to send and receive facsimile communications over the Internet. At least one of the one or more fax machine(s) 105 is/are able to send and receive facsimile communications over both the PSTN and the Internet.

In some embodiments, at least one of the one or more fax machine(s) 105 include(s) printing capabilities for printing received facsimile communications. In some embodiments, at least one of the one or more fax machine(s) 105 is coupled to at least one of the one or more printer(s) 104 and sends data to the printer(s) 104 for printing.

The one or more server(s) 106 each include hardware, software, or both for providing the functionality of the respective one or more server(s) 106. In some embodiments, at least one of the one or more server(s) 106 is unitary. In some embodiments, at least one of the one or more server(s) 106 is distributed. At least one of the one or more server(s) 106 may span multiple locations. At least one of the one or more server(s) 106 may span multiple machines. In some embodiments, two or more of the one or more server(s) 106 reside in a single computing system in any suitable manner. In some embodiments, at least one of the one or more server(s) 106 includes software that is provided as a part of a software application. In some embodiments, at least one of the one or more server(s) 106 includes software that is provided as a stand-alone software application.

In some embodiments, at least one of the one or more server(s) 106 provides one or more network services for the image processing device 101. Examples of network services include directory services, authentication services, naming services, and secure access to resources on the network 108. In some embodiments, at least one of the one or more server(s) 106 receives one or more files from the image processing device 101 when the image processing device 101 executes a scan and send process. One or more of the server(s) 106 may be coupled to one or more of the data store(s) 107.

In some embodiments, at least one of the one or more server(s) 106 provides an authentication service. The image processing device 101 and/or the application 103 on the image processing device 101 may use the authentication service to authenticate a network entity, such as a user, seeking access to resources on the image processing device 101. The authentication service may use the Kerberos protocol or other suitable authentication method to authenticate the network entity. The authentication service may be coupled to one of the data store(s) 107, which may contain account information for network entities. The account information may include an object and its attributes. An object may represent a user or another entity within the network 108. Attributes for a user account may include, for example, the user's password, a smart card identification number, or group membership information indicating a group to which the user belongs. When providing authentication services, the authentication service may access account information in the data store 107 for the relevant entity and provide an authentication result.

In some embodiments, at least one of the one or more server(s) 106 is a file server. In some embodiments, at least one of the one or more server(s) 106 is a mail server. In some embodiments, at least one of the one or more server(s) 106 is a web server. In some embodiments, at least one of the one or more server(s) 106 is an application server. In some embodiments, at least one of the one or more server(s) 106 is a fax server. In some embodiments, at least one of the one or more server(s) 106 is a database server.

The network 108 couples one or more servers and one or more clients to each other. The network 108 may be any suitable network. For example, one or more portions of the network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 108 may include one or more networks.

FIG. 2 is described with reference to the example network environment 100 of FIG. 1. FIG. 2 illustrates an example flow of operations at the image processing device 101.

In step S201, a login process is performed at the image processing device 101. By virtue of the login process, access to one or more resources on the image processing device 101 is granted based on a credential associated with a user. Examples of the credential include the following: user identification information (for example, a username), a password, security token information (for example, a token identifier such as the identification number of a smart card), a PIN, biometric information, a certificate, other information associated with the user, or a combination of two or more of these.

In some embodiments, step S201 comprises performing the operations of FIG. 4. By way of example and not by way of limitation, step S201 may comprise performing steps S401, S402, S403, S405, S406 and S409 of FIG. 4, according to some embodiments. Further by way of example and not by way of limitation, step S201 may comprise performing steps S401, S402, S403, S405, S406, S407, S408 and S409 of FIG. 4, according to some embodiments.

In some embodiments, step S201 includes receiving the credential from a user. A user may provide one or more inputs at an operation panel of the image processing device 101. For example, the user may input a username and password by providing touch inputs to interface elements displayed on a touch sensitive display and/or by pressing one or more hard buttons on a hard key panel. Additionally or alternatively, a user may provide one or more inputs via one or more input/output (I/O) port(s) of the image processing device 101 that enable one or more external device(s) to communicate with the image processing device 101. For example, the user may provide information to the image processing device 101 via a near field communication (NFC) interface, a smart card reader, radio-frequency identification (RFID) reader, device for detecting biometric information, a keyboard, or other suitable external device connected to the image processing device 101 via an I/O port.

In some embodiments, step S201 includes retrieving the credential. For example, the application 103 executing on the image processing device 101 may provide functionality for retrieving the credential from a storage location, such as a memory on the image processing device 101 or a remote storage location. The application 103 executing on the image processing device 101 may retrieve the credential in response to receiving an event notification. For example, the application 103 may include single sign-on functionality and may retrieve the credential in response to receiving notification of a user login event.

After obtaining the credential, the application 103 running on the image processing device 101 determines whether the credential is valid. In some embodiments, an authentication service is used to determine whether the credential is valid. For example, the authentication service and the application 103 running on the image processing device 101 may communicate and execute various processes according to an authentication protocol such as Kerberos or other suitable authentication protocol, in order to determine whether the credential is valid. In some embodiments, the application 103 running on the image processing device 101 determines whether the credential is valid by comparing the credential to user information on an access control list stored locally.

In response to determining the credential is valid, access is granted to one or more resources on the image processing device 101. For example, a login session is established for the user such that the user is logged in to the application 103 on image processing device 101 by virtue of the credential. On the other hand, in response to determining the credential is not valid, access to the one or more resources on the image processing device 101 is denied and the process ends.

In step S202, a request to perform a scan and send process is received at the image processing device. In some embodiments, the request to perform the scan and send process comprises instructions for scanning a physical document and sending an electronic document representing the scanned physical document to a destination. The request to perform the scan and send process is received at the image processing device 101 while the user is logged in to the application 103 on image processing device 101.

In some embodiments, the request to perform the scan and send process is based on one or more user inputs via an operation panel of the image processing device 101. The one or more user inputs may include a user input via a hard key panel of the image processing device 101. For example, the user may press a start button in order to submit the request to perform the scan and send process. The one or more user inputs may include a user input via a touch sensitive display of the image processing device 101. For example, the user may touch an interface element displayed on a touch sensitive display in order to submit the request to perform the scan and send process. The request to perform the scan and send process may include an instruction to perform an image scanning operation on multiple physical documents placed in an automatic document feeder (ADF) of the image processing device 101.

In some embodiments, the request to perform the scan and send process includes information pertaining to the scanning operation. For example, the request to perform the scan and send process may include scan settings pertaining to a resolution of the scan, color or black and white settings, contrast settings, file type settings for the electronic document resulting from the scan operation, or other scan settings for the scanning operation. The scan settings included in the request to perform the scan and send process may be preset or default settings stored in the image processing device 101. In some embodiments, the scan settings included in the request to perform the scan and send process may be custom settings set in the image processing device 101 by a user via an operation panel of the image processing device 101.

In some embodiments, the request to perform the scan and send process includes instructions for sending an electronic document representing the scanned physical document to a destination. By way of example and not by way of limitation, the request may include one or more of the following as destination information: a path for a network directory, a uniform resource locator (URL) associated with a web application, a URL associated with a File Transfer Protocol (FTP) server, a fax number, an electronic mail (email) address, or other suitable information indicating a destination for the electronic document. In some embodiments, the request to perform the scan and send process may include instructions for sending the electronic document to multiple destinations. In some embodiments, instructions for sending the electronic document to one or more destinations are set at the image processing device 101 by a user via an operation panel of the image processing device 101. In some embodiments, instructions for sending the electronic document to one or more destinations may be automatically set based on preset or default settings associated with the logged-in user.

In some embodiments, the request to perform the scan and send process includes other information related to the scan and send process. For example, the request to perform the scan and send process may include information that identifies a matter (for example, a matter identifier) or a client (for example, a client identifier) associated with the scan and send process. In some embodiments, the request to perform the scan and send process further includes a file name for the file resulting from the scan and send process. The information that identifies a matter, the information that identifies a client, and the file name may each be set by a user via an operation panel of the image processing device 101 or may be automatically set based on preset or default settings.

In step S203, the scan and send process is initiated. In some embodiments, the application 103 executing on the image processing device 101 initiates the scan and send process in response to receiving the request to perform the scan and send process in step S202.

In some embodiments, the image processing device 101 scans one or more physical documents. A physical document may, for example, be placed on a glass platen or in an ADF of the image processing device 101. In some embodiments, multiple physical documents have been placed in the ADF of the image processing device 101. A scanner unit of the image processing device 101 performs a scanning operation on successive sheets of the one or more physical documents. An image sensor scans each physical document to generate electrical signals which are converted to digital image data representing each scanned physical document. The digital image data is converted into an electronic document representing the one or more scanned physical documents.

In some embodiments, in converting the digital image data into the electronic document, one or more processor(s) of the image processing device 101 perform format conversion processing. For example, one or more processor(s) of the image processing device 101 may convert the digital image data to an electronic document in a particular file format, such as portable document format (PDF), a TIFF file format, or some other file format for sending the electronic document to a destination. In some embodiments, the image processing device 101 executes one or more other image processing techniques on the electronic document, such as optical character recognition (OCR).

Instructions for performing file format conversion or for performing various image processing techniques may be stored in a storage device of the image processing device 101 and may be executed by one or more processor(s) of the image processing device 101. In some embodiments, commands for performing these or other image processing techniques may be included in the request to perform the scan and send process. For example, the request to perform the scan and send process may indicate a format into which the digital image data should be converted for sending the electronic document representing the scanned physical document(s) to a destination.

After scanning the one or more physical documents, performing image processing, and generating the electronic document representing the scanned physical document(s), the image processing device 101 sends the electronic document to the destination specified in the request to perform the scan and send process received in step S202. The time required to complete the scan and send process initiated in step S203 may vary depending upon, for example, a number of physical documents involved in the scan and send process, the type(s) of image processing to be performed, and the method of transmitting the data to the destination.

In some embodiments, a request to perform a second scan and send process may be received and the second scan and send process initiated while execution of another scan and send process is still in progress. For example, image processing for a first scan and send process may be in progress after completion of a scanning operation for the first scan and send process. And during execution of the image processing for the first scan and send process, the second scan and send process may be initiated at the image processing device 101. Accordingly, multiple scan and send processes may be in progress simultaneously, according to some embodiments.

In step S204, a log out command is received at the image processing device 101. The log out command may be based on the occurrence of an event that causes the user to be logged out of the application 103. Examples of events that may cause the user to be logged out of the application 103 include but are not limited to the following: receiving a user input to a touch sensitive display at a position where an interface element for logging out of the application 103 is displayed; navigating away from the application 103 in a graphical user interface displayed on the image processing device 101; receiving a user input to a reset button on the hard key panel of the image processing device 101; and determining that a lapse of a predetermined amount of time has occurred without receiving a user input operation. In some embodiments, step S204 includes the application 103, which is executing on the image processing device 101, receiving information indicating that an event that causes the user to be logged out of the application 103 has occurred.

In some embodiments, the log out command received in step S204 is received during execution of the scan and send process initiated in step S203. In some embodiments, the log out command received in step S204 is received after execution of the scan and send process initiated in step S203 has terminated.

In step S205, it is determined whether execution of the scan and send process is in progress. In some embodiments, the application 103 executing on the image processing device 101 determines whether execution of the scan and send process is in progress in response to receiving the log out command in step S204.

In some embodiments, step S205 includes determining whether a set of instructions associated with the scan and send process initiated in step S203 is currently being executed. Based on a status of carrying out the instructions of the scan and send process, the application 103 executing on the image processing device 101 may determine whether the scan and send process is in progress.

By way of example, a scanning operation of the scan and send process may be complete but image processing may be in progress. For example, one or more processors of the image processing device 101 may be executing instructions that cause the one or more processors to perform format conversion processing, image compression, color conversion processing, operations to remove distortion, OCR, another image processing technique, or a combination of two or more of these. Accordingly, the application 103 executing on the image processing device 101 may currently be waiting for completion of the image processing. Based on the current status, the application 103 executing on the image processing device 101 may determine in step S205 that the scan and send process is in progress.

Further by way of example, a scanning operation and all image processing may be completed for a scan and send process, but the image processing device 101 may be transmitting the electronic document to the destination at the time it is determined whether execution of the scan and send process is in progress. Accordingly, the application 103 executing on the image processing device 101 may determine in step S205 that the scan and send process is in progress based on the status of the transmission.

Still further by way of example, execution of all processing associated with the scan and send process initiated in step S203 may have terminated by the time it is determined whether execution of the scan and send process is in progress. For example, one or more physical documents may have been scanned and an electronic document representing the scanned physical document(s) may have been sent to a specified destination. Accordingly, the application 103 executing on the image processing device 101 may determine in step S205 that execution of the scan and send process is not in progress based on the status of carrying out the instructions of the scan and send process.

In some embodiments, multiple scan and send processes may have been executed or may be executing during a user's login session. In some embodiments, in step S205, it is determined for each of multiple scan and send processes, whether execution of each respective scan and send process is in progress.

In step S206, in response to determining that execution of a scan and send process is in progress (Yes in step S206), the process advances to step S209. On the other hand, in response to determining that execution of a scan and send process is not in progress (No in step S206), the process advances to step S207.

In step S207, a log out process is performed at the image processing device 101. In some embodiments, the application 103 executing on the image processing device 101 performs the log out process of step S207 in response to the log out command received in step S204 and based on the determination that execution of a scan and send process is not in progress.

In some embodiments, step S207 includes terminating the user's login session on the application 103 and deleting data associated with the user's login session. In some embodiments, the application 103 terminates the user's login session on the application 103 by causing processes belonging to the user's login session on the application 103 to be terminated. In some embodiments, the application 103 deletes data associated with the user that was received in step S201. For example, the application 103 may delete information that identifies the user (such as a username or other identifier), the credential, domain information, or other data associated with the user or the user's session. In some embodiments, the application 103 deletes data associated with one or more scan and send process(es) that were completed during the user's login session. For example, the application 103 may delete information received in step S202 in conjunction with the request to perform a scan and send process. In some embodiments, the application 103 deletes graphical user interface information associated with the user or the user's session. The application 103 may delete information from one or more storage locations. Data may be cleared from a cache memory, deleted from other memory, erased from a hard disk, or removed from another data storage device.

In step S208, a login screen is presented in the user interface 102 of the image processing device 101. In some embodiments, the application 103 prepares a login page for display. The login page may include information corresponding to the appropriate credential necessary for login, or other information to aid a user. For example, the login page may include fields for receiving data. In some embodiments, the login page is prepared but not displayed in the user interface 102 until a user seeks to access the application 103. Since the processing necessary to prepare the login page is completed prior to the user's accessing the application 103, the page can quickly be presented when the user seeks to access the application 103.

Referring again to step S206, in response to determining that execution of a scan and send process is in progress (Yes in step S206), the process advances to step S209.

In step S209, a log out process is performed that enables execution of one or more scan and send process(es) to continue. In some embodiments, the application 103 executing on the image processing device 101 performs the log out process of step S209 in response to the log out command received in step S204 and based on the determination that execution of a scan and send process is in progress.

In some embodiments, step S209 includes identifying one or more processes and any data which is/are necessary for execution of the scan and send process(es) to continue. For example, processes related to the scan and send process(es) determined to be in progress may be maintained. By way of example, a format conversion process may be identified as related to a scan and send process in progress. Accordingly, the format conversion processing may continue uninterrupted as part of the scan and send process.

Additionally, data necessary for execution of the scan and send process to continue may also be maintained. For example, information received in step S202 in conjunction with the request to perform a scan and send process (which is currently in progress) may be maintained. This may include destination information, scan settings, a credential associated with the user, a credential associated with the destination, or other information associated with the user, the user's session, and/or the scan and send process(es) in progress.

In some embodiments, step S209 includes causing one or more processes belonging to the user's login session on the application 103 to be terminated and/or deleting some data associated with the user's login session. For example, the application 103 may cause processes to be terminated which are unnecessary for execution of the scan and send process(es) to continue. Additionally, the application 103 may delete data which is not necessary for execution of the scan and send process(es) to continue. For example, the application 103 may delete graphical user interface information associated with the user or the user's session which is unnecessary to maintain because the information will no longer be presented to the display. Additionally, data related to scan and send processes that were completed before the log out command was received in step S204 may be deleted.

In step S210, a login screen is presented in the user interface 102 of the image processing device 101 while execution of the scan and send process continues in the background. The scan and send process continues executing even though an active screen for the application 103 is no longer displayed in the user interface 102 for the user. In some embodiments, the application 103 prepares a login page for display. The login page may include information corresponding to the appropriate credential necessary for login, or other information to aid a user. For example, the login page may include fields for receiving data. In some embodiments, the login page is prepared but not displayed in the user interface 102 until a user seeks to access the application 103. Since the processing necessary to prepare the login page is completed prior to the user's accessing the application 103, the page can quickly be presented when the user seeks to access the application 103.

In some embodiments, a user other than the user associated with the scan and send process executing the in background signs in to the application 103 while the scan and send process is executing in the background.

Information associated with the scan and send process executing in the background may not be visible to the currently logged-in user. Additionally, the currently logged-in user may not be able to access data or interfere with processes associated with the scan and send process executing in the background. For example, the instructions for the scan and send process continue to be executed but information associated with the scan and send process is not presented in the user interface 102.

In some embodiments, the scan and send process continues executing in the background until execution of the scan and send process has terminated.

In step S211, when execution of the scan and send process has terminated, data associated with the scan and send process is stored. In some embodiments, execution of the scan and send process is terminated when the instructions associated with the scan and send process initiated in step S203 have been carried out. In some embodiments, execution of the scan and send process is terminated and the scan and send process succeeded. In some embodiments, execution of the scan and send process is terminated and the scan and send process failed.

In some embodiments, the data stored in step S211 may be used to generate a report for display to the user upon subsequent login by the user. By way of example, since execution of the scan and send process was in progress when the user logged out, when the user subsequently logs in, the user may be presented information indicating a result of the scan and send process. The information presented to the user upon subsequent login may be generated based on the data associated with the scan and send process that is stored in step S211.

In some embodiments, step S211 includes the application 103 executing on the image processing device 101 to store data associated with the scan and send process in one or more storage locations. The data associated with the scan and send process may be stored in memory on the image processing device 101. The data associated with the scan and send process may be stored in a storage device, such as a hard disk, on the image processing device 101 or coupled to the image processing device 101.

In some embodiments, the application 103 executing on the image processing device 101 may send the data associated with the scan and send process to a remote computing system for storage. For example, in some embodiments, step S211 includes sending the data associated with the scan and send process to one of the one or more server(s) 106. The data associated with the scan and send process may be stored in one of the one or more data store(s) 107 associated with the server 106. In some embodiments, when the user associated with the scan and send process subsequently logs in to the application 103, the application 103 executing on the image processing device 101 may request the data associated with the scan and send process from the server 106 in order to present information, at the image processing device 101, indicating a result of the scan and send process.

In some embodiments, step S211 includes sending the data associated with the scan and send process to one or the one or more printer(s) 104, which may be a multifunction peripheral. In some embodiments, when the user associated with the scan and send process subsequently logs in to the application 103, the application 103 executing on the image processing device 101 may request the data associated with the scan and send process from the printer 104 in order to present information, at the image processing device 101, indicating a result of the scan and send process.

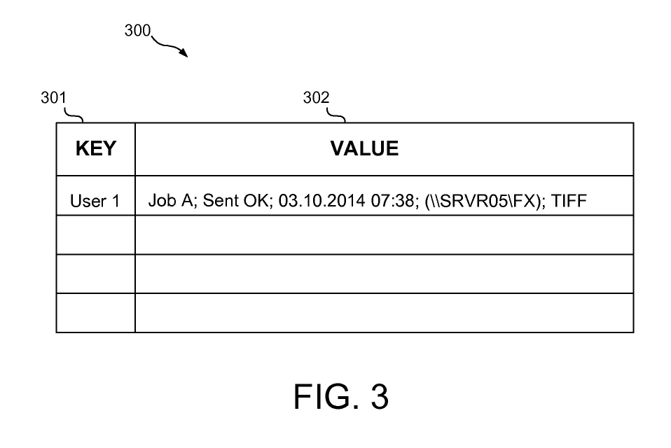

In step S211, the data associated with the scan and send process may be stored in any suitable manner. Step S211 is described further with reference to FIG. 3.

FIG. 3 illustrates an example data structure 300. The example data structure 300 includes a Key 301 and Value 302. The example data structure 300 includes an entry “User 1” as a Key. The example data structure 300 includes an entry “Job A; Sent OK; 03.10.2014 07:38; (\\SRVR05\FX); TIFF” as a Value.

Any suitable data structure may be used to store the data associated with the scan and send process. For example, the data associated with the scan and send process may be stored in an array comprising a container object holding a number of elements associated with an index. For example, the index may have the value “User 1” and the elements associated with the index may have the following values: “Job A,” “Sent OK,” “03.10.2014 07:38,” “(\\SRVR05\FX),” and “TIFF.”

By way of example, the entries in the example data structure 300 of FIG. 3 were added into the example data structure 300 in step S211. In step S211, the application 103 executing on the image processing device 101 added an entry “User 1” to the example data structure 300. The identifier “User 1” is information associated with a user (User 1) who is associated with the scan and send process. For example, “User 1” may be a username associated with the user who was granted access to one or more resources on the image processing device 101 based on a credential in step S201.

In step S211, additional data associated with the scan and send process was also added to the example data structure 300. The identifier “Job A” is information that identifies the scan and send process requested in step S202. In some embodiments, the identifier “Job A” may represent information that identifies the file (i.e., file name) resulting from the scan and send process. The identifier “Sent OK” is information indicating a status or result associated with the scan and send process. For example, the entry “Sent OK” is information indicating that the scan and send process was completed successfully. The information “03.10.2014 07:38” is information indicating a date and time that execution of the scan and send process terminated. For example, the information “03.10.2014 07:38” is information indicating that execution of the scan and send process terminated Mar. 10, 2014 at 7:38 AM. The information “(\\SRVR05\FX)” is information indicating a destination to which the result of the scan and send process was sent. For example, “(\\SRVR05\FX)” is information indicating that the destination for the scan and send process is a directory “FX” on a network server “SRVR05.” The information “TIFF” is information indicating a file type of the file resulting from the scan and send process. For example, the information “TIFF” is information indicating that the file send in the scan and send process was a TIFF file.

The data associated with the scan and send process may include types of data different from the entries in the example data structure 300 of FIG. 3. For example, information identifying a matter, a client, a domain, the image processing device 101, a file size, or other suitable information associated with the user or the scan and send process may be included as data associated with the scan and send process in step S211.

The data stored in the example data structure 300 may be used to generate a report for display to User 1 upon subsequent login by User 1. For example, since execution of the scan and send process was in progress when User 1 logged out, when User 1 subsequently logs in, User 1 may be presented information indicating a result of the scan and send process based on the data associated with the scan and send process that is in the example data structure 300.

FIG. 4 is described with reference to the example network environment 100 of FIG. 1. FIG. 4 illustrates an example flow of operations at the image processing device 101. In some embodiments, step S201 of FIG. 2 comprises the operations of FIG. 4.

In step S401, a credential associated with a user and a request to access one or more resources on the image processing device 101 are received at the image processing device 101. Examples of the credential include the following: user identification information (for example, a username), a password, security token information (for example, a token identifier such as the identification number of a smart card), a PIN, biometric information, a certificate, other information associated with the user, or a combination of two or more of these.

In some embodiments, step S401 may include the application 103 providing a page to the user interface 102 that enables a user to sign in to the application 103. The page may include form elements for inputting a credential such as a username and password. In some embodiments, the image processing device 101 receives the credential. For example, a user may provide the credential via the user interface 102 of the image processing device 101. The credential may be a username and password.

In step S402, it is determined whether the credential received in step S401 is valid. In some embodiments, the application 103 executing on the image processing device 101 determines whether the credential is valid in response to receiving the credential in step S401.

In some embodiments, the application 103 uses a remote authentication service to determine whether the credential is valid. For example, the application 103 executing on the image processing device 101 may send the credential to an authentication service with a request to authenticate the user. The authentication service may use the Kerberos protocol or other suitable authentication method to authenticate the user. The authentication service then sends an authentication response to the application 103 indicating whether the authentication was successful or the authentication failed. If the authentication was successful, the application 103 determines that the credential is valid. On the other hand, if the authentication failed, the application 103 determines that the credential is not valid.

In some embodiments, the application 103 determines whether the credential is valid by comparing the credential to user information on an access control list stored locally. Based on the comparison, the application 103 may determine, for example, the credential is valid in a case the credential matches some user information on the access control list, or the credential is not valid in a case the credential does not match some user information on the access control list.

In step S403, in response to determining that the credential is not valid (No in step S403), the process advances to step S404. In step S404, the application 103 executing on the image processing device 101 performs processing in response to the authentication failure. For example, the application 103 executing on the image processing device 101 may prepare and present to the user interface 102 information that, when displayed on a display of the image processing device 101, provides a message to a user that authentication has failed or that the user is denied access to one or more resources of the application 103. The message may include a request that the user provide a credential again, for example. On the other hand, in response to determining that the credential is valid (Yes in step S403), the process advances to step S405.

In step S405, it is determined whether information associated with the user matches an entry in a data structure. The information associated with the user may be any identifier associated with the user. In some embodiments, the identifier is information that identifies the user. For example, the identifier may be a username of the user. In some embodiments, the identifier is information that identifies an entity associated with the user. For example, the identifier may be an identification number of a smart card or other security token associated with the user. In some embodiments, the information associated with the user is information received in step S401. For example, the credential may include the information associated with the user or the credential may be the information associated with the user. In some embodiments, the information associated with the user is retrieved by the application 103 executing on the image processing device 101.

In step S405, the application 103, executing on the image processing device 101, may determine whether information associated with the user matches an entry in a data structure in response to the determination that the credential received in step S401 is valid. In some embodiments, the data structure checked for a matching entry in step S405 is the data structure into which the data associated with the scan and send process was added in step S211 of FIG. 2.

In some embodiments, step S405 includes determining whether the information associated with the user matches an entry in a data structure by comparing an identifier to information stored locally. For example, the application 103 executing on the image processing device 101 may search a data structure in a memory of the image processing device 101 and compare the information associated with the user to entries in the data structure. In some embodiments, the data structure includes one or more entries as Keys or indexes. The application 103 executing on the image processing device 101 may search the data structure and compare the information associated with the user to the Key values or the index values.

In some embodiments, step S405 includes determining whether the information associated with the user matches an entry in a data structure by comparing an identifier to information stored remotely. For example, the application 103 executing on the image processing device 101 may determine whether the information associated with the user matches an entry in one of the data store(s) 107. For example, the application 103 executing on the image processing device 101 may use one of the server(s) 106 to determine whether an entry in the data store 107 matches the information associated with the user. The application 103 may request one of the server(s) 106 to perform a search operation, for example using Lightweight Directory Access Protocol (LDAP), to search one of the data store(s) 107 for an entry that matches the information associated with the user. The server 106 may search the data store 107 and compare an identifier to entries in the data store 107. The application 103 may then receive from the server 106 a result of the search performed by the server 106. For example, the application 103 may receive an indication that an entry in the data store 107 matched the identifier or an indication that no entry in the data store 107 matched the identifier.

In some embodiments, one of the server(s) 106 may provide a centralized service for multiple image processing devices. For example, multiple image processing devices similar to the image processing device 101 may be attached to the network 108 and may use the server 106 to manage data associated with scan and send processes of the respective image processing devices. By way of example, multiple image processing devices may each perform operations such as described with respect to FIG. 2 and may each, in step S211, send data to the centralized service. Subsequently, a user from any one of the multiple image processing devices may log in to a different one of the multiple image processing devices and the image processing device at which the user is logged in may request the centralized service to search for data associated with a scan and send process for the logged-in user.

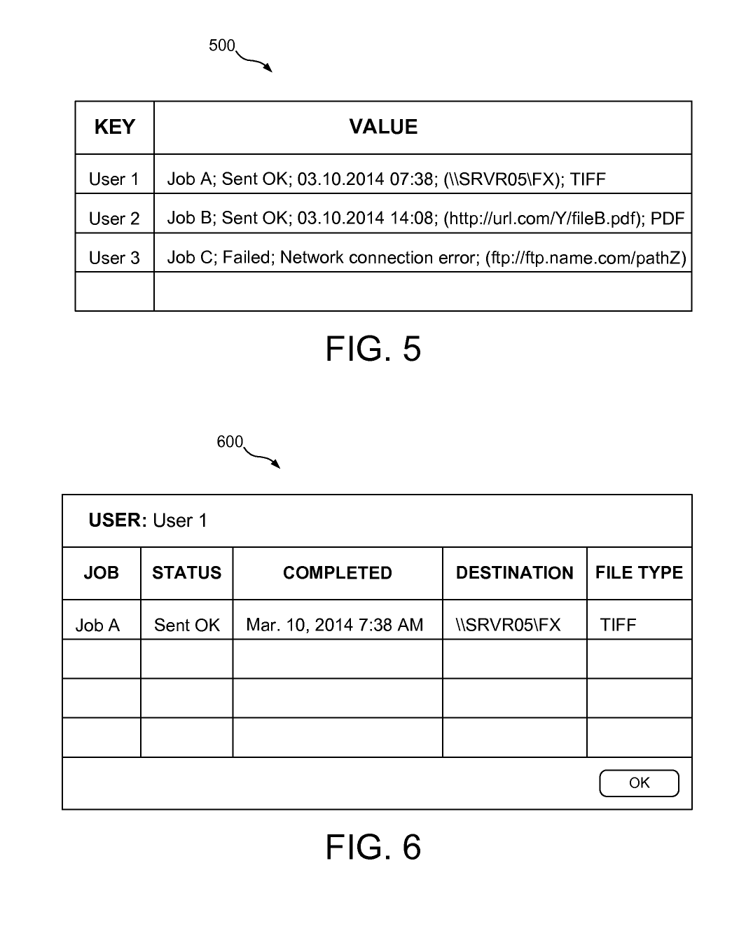

Step S405 is described further with reference to FIG. 5. FIG. 5 illustrates an example data structure 500. The example data structure 500 includes the following three entries as Key values: “User 1,” “User 2,” and “User 3.” The entries “User 1,” “User 2,” and “User 3,” are each associated with a respective scan and send process for which data is stored in the example data structure 500. The scan and send process associated with User 1 was described with respect to FIG. 3. The scan and send process associated with User 2 is a scan and send process for which a file was successfully sent to a web application on one of the server(s) 106 after User 2 was logged out. The scan and send process associated with User 3 is a scan and send process that failed to send a file to an FTP server due to a network connection error after User 3 was logged out.

By way of example, User 1 may have provided a credential that was determined to be valid. In step S405, it is determined whether information associated with User 1 matches an entry in the example data structure 500 of FIG. 5. The application 103 executing on the image processing device 101 compares information associated with User 1 to data in the example data structure 500. For example, User 1 may have provided a username and password as a credential in step S401, where the username is the identifier “User 1.” Accordingly, in step S405, it is determined whether the identifier “User 1” matches a Key value in the example data structure 500. Since the identifier “User 1” is included as an entry in the example data structure 500, it is determined in step S405 that the information associated with the user matches an entry in the data structure.

In step S406, in response to determining that the information associated with the user does not match an entry in the data structure (No in step S406), the process advances to step S409. On the other hand, in response to determining that the information associated with the user matches an entry in the data structure (Yes in step S406), the process advances to step S407.

In step S407, information about the scan and send process is presented on a display of the image processing device 101. In some embodiments, the application 103 executing on the image processing device 101 presents the information about the scan and send process on the display in response to the determination that the information associated with the user matches an entry in the data structure. The information about the scan and send process presented on the display may be generated based on the data stored in the data structure in step S211.

Step S407 is described further with reference to FIG. 6. FIG. 6 illustrates an example graphical user interface 600 on a display of the image processing device 101. The example graphical user interface 600 is presented on the display in response to the determination that the identifier “User 1” associated with User 1 matches an entry in the example data structure 500 of FIG. 5. The example graphical user interface 600 presented on the display is generated based on the data associated with the scan and send process stored in the data structure in step S211. In the example data structure 500, the data associated with User 1's scan and send process includes the following: “Job A; Sent OK; 03.10.2014 07:38; (\\SRVR05\FX); TIFF.”

In the example graphical user interface 600, textual information and an OK button are presented on the display of the image processing device. The textual information includes text indicating various information about the scan and send process associated with User 1. For example, textual information indicating a job name and/or a file name is presented. Textual information indicating a result of the scan and send process is presented. Textual information indicating a date and time of completion of the scan and send process is presented. Textual information indicating a destination to which the file resulting from the scan and send process was sent is presented. Textual information indicating a file type is presented. Textual information indicating the logged-in user is also presented. In addition to the textual information, an interface element is also presented. The OK button is an interface element enabling a user to close the window currently presented by selecting the OK button. By closing the status report shown in FIG. 6, the user navigates to a logged-in screen associated with the application 103 and one or more resources of the application 103 will be accessible.

The information presented in step S407 may be presented in any suitable format. For example, the application 103 executing on the image processing device 101 may generate a screen that occupies the entire display area of the image processing device. In some embodiments, a window may be generated that occupies a portion of the display area. In some embodiments, information may be generated and integrated into an already-presented graphical user interface screen as additional information, such as textual information.

In addition to the information presented in the example graphical user interface 600 of FIG. 6, other suitable information described herein may additionally or alternatively be presented.

In some embodiments, the feature of step S407 may be configurable. For example, an administrator or user may turn on or turn off the functionality of presenting the information indicating the result of the scan and send process upon subsequent login. In some embodiments, a default setting in the application 103 is to perform the operation of step S407 such that the information is automatically presented upon subsequent login without requiring any user input operation directed to obtaining the status report. In some embodiments, an administrator or user may configure the application 103 to present the information indicating the result of the scan and send process in particular scenarios. For example, the application 103 may be configured to execute the operations of step S407 for particular users, for particular destinations, for particular types of destinations, or based on another factor or combination of factors.

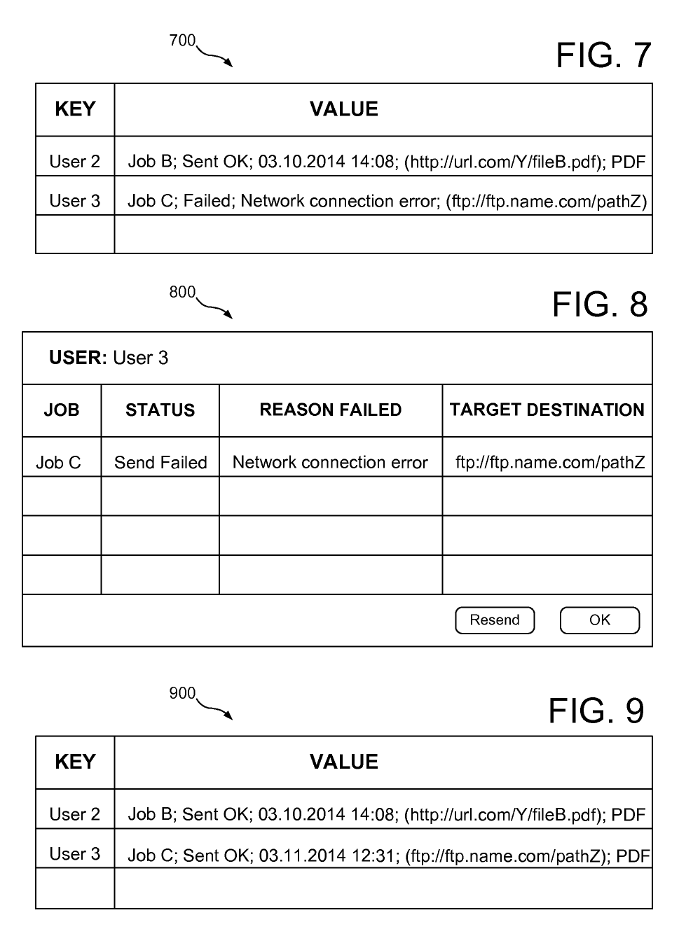

In step S408, data associated with the logged-in user may be deleted from the data structure. By way of example, after User 1 logged in and was presented the example graphical user interface 600, the data structure is updated as illustrated in the example data structure 700 of FIG. 7. In the example data structure 700 of FIG. 7, the information associated with User 1 has been removed and only the residual entries in the data structure remain.

In step S409, the user is logged in to the application 103, the image processing device 101 and/or one or more resources of the application 103 and/or image processing device 101.

With reference to FIGS. 7, 8 and 9, a scenario is described in which User 3 logs in to the application 103. By way of example, User 3 may have provided a credential that was determined to be valid. In step S405, it is determined whether information associated with User 3 matches an entry in the example data structure 700 of FIG. 7. The application 103 executing on the image processing device 101 compares information associated with User 3 to data in the example data structure 700. For example, User 3 may have provided a username and password as a credential in step S401, where the username is the identifier “User 3.” Accordingly, in step S405, it is determined whether the identifier “User 3” matches a Key value in the example data structure 700. Since the identifier “User 3” is included as an entry in the example data structure 700, it is determined in step S405 that the information associated with the user matches an entry in the data structure.

The example graphical user interface 800 is presented on the display in response to the determination that the identifier “User 3” associated with User 3 matches an entry in the example data structure 700 of FIG. 7. The example graphical user interface 800 presented on the display is generated based on the data associated with the scan and send process stored in the data structure for User 3. In the example data structure 700, the data associated with User 3's scan and send process includes the following: “Job C; Failed; Network connection error; (ftp://ftp.name.com/pathZ).”

In the example graphical user interface 800, textual information, an OK button, and a Resend button are presented on the display of the image processing device. The textual information includes text indicating various information about the scan and send process associated with User 3. For example, textual information indicating a job name and/or a file name is presented. Textual information indicating a result of the scan and send process is presented. Textual information indicating a reason why the scan and send process failed is presented. Textual information indicating a target destination to which the file resulting from the scan and send process was meant to be sent is presented. Textual information indicating the logged-in user is also presented. In addition to the textual information, interface elements are also presented. The OK button is an interface element enabling a user to close the window currently presented by selecting the OK button. By closing the status report shown in FIG. 8, the user navigates to a logged-in screen associated with the application 103 and one or more resources of the application 103 will be accessible. The Resend button is an interface element enabling a user to resend the file that failed to be sent.

By pressing the Resend button, an instruction is received to retrieve the file from a storage location and attempt to resend the file to the target destination. For example, when the scan and send process failed, the application 103 executing on the image processing device 101 stores the unsent file in memory or on a storage device of the image processing device 101, according to some embodiments. In some embodiments, a file that failed to be sent to a destination may be automatically deleted after a lapse of a predetermined amount of time has occurred since the scan and send process failed. In some embodiments, an attempt to resend a file that failed to be sent to a destination may be automatically initiated without requiring a user request after a lapse of a predetermined amount of time has occurred since the scan and send process failed. In some embodiments, multiple failed jobs may be presented on a graphical user interface. In order to select a particular job or jobs to send from among the failed jobs listed, a user may be required to touch a job on the screen in order to select the job. Then the selected job(s) will be highlighted. Pressing the Resend button will then initiate the Resend command for the selected jobs.

By way of example, User 3 may have resent Job C by selecting the Resend button (step S202, S203). Then, User 3 may have logged out of the application 103 while the scan and send process was executing again for Job C (step S204, S205, S206, S209). Accordingly, data associated with the scan and send process of Job C is stored in the example data structure 900 of FIG. 9 (step S210, S211). When User 3 logs back into the application 103 or back in to another image processing device 101 on the network 108, according to some embodiments, User 3 will be presented with information indicating that Job C was sent successfully to the FTP server (FIG. 4).

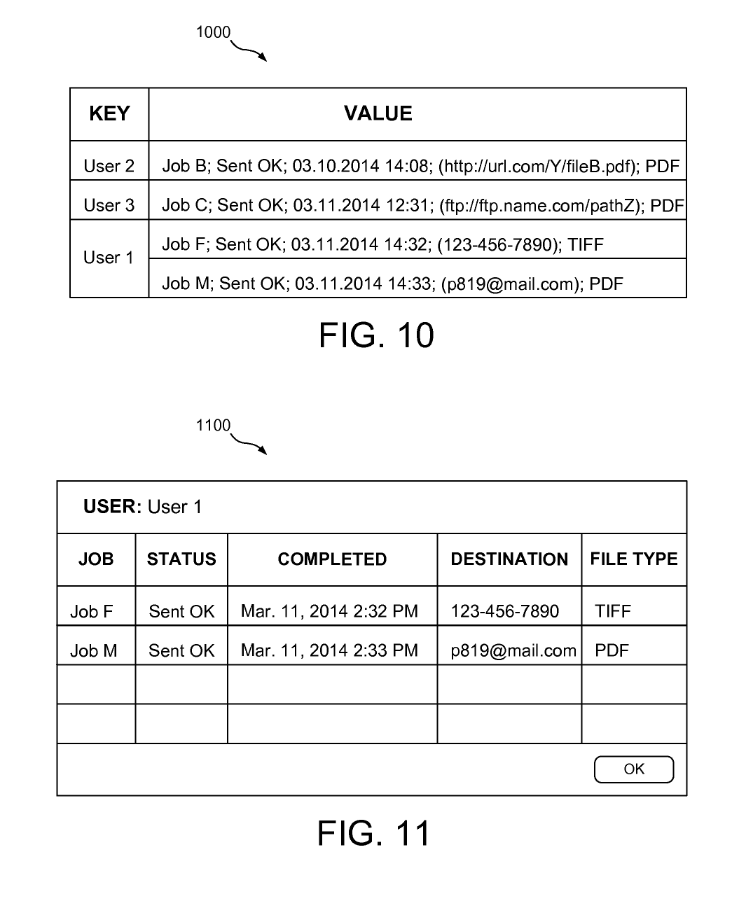

With reference to FIGS. 10 and 11, a scenario is described in which User 1 logs in to the application 103. By way of example, User 1 may have provided a credential that was determined to be valid. In step S405, it is determined whether information associated with User 1 matches an entry in the example data structure 1000 of FIG. 10. The application 103 executing on the image processing device 101 compares information associated with User 1 to data in the example data structure 1000. For example, User 1 may have provided a username and password as a credential in step S401, where the username is the identifier “User 1.” Accordingly, in step S405, it is determined whether the identifier “User 1” matches a Key value in the example data structure 1000. Since the identifier “User 1” is included as an entry in the example data structure 1000, it is determined in step S405 that the information associated with the user matches an entry in the data structure.

The example graphical user interface 1100 is presented on the display in response to the determination that the identifier “User 1” associated with User 1 matches an entry in the example data structure 1000 of FIG. 10. The example graphical user interface 1100 presented on the display is generated based on the data associated with the scan and send processes stored in the data structure for User 1. In the example data structure 1000, the data associated with User 1's scan and send processes includes the following: “Job F; Sent OK; 03.11.2014 14:32; (123-456-7890); TIFF” and “Job M; Sent OK; 03.11.2014 14:33; (p819@mail.com); PDF.” Multiple scan and send processes are stored in the example data structure 1000 for User 1 because Job F and Job M were both in progress when User 1 logged out of the application 103 (step S204, S205, S206, S209).

In the example graphical user interface 1100, textual information and an OK button are presented on the display of the image processing device. The textual information includes text indicating various information about the scan and send processes associated with User 1. For example, textual information indicating a job name and/or a file name is presented for each scan and send process. Textual information indicating a result of each of the scan and send processes is presented. Textual information indicating a date and time of completion of each of the scan and send processes is presented. Textual information indicating each destination to which the files resulting from the respective scan and send processes was sent is presented. Textual information indicating the respective file types is presented. Textual information indicating the logged-in user is also presented. In addition to the textual information, an interface element is also presented. The OK button is an interface element enabling a user to close the window currently presented by selecting the OK button. By closing the status report shown in FIG. 6, the user navigates to a logged-in screen associated with the application 103 and one or more resources of the application 103 will be accessible.

FIG. 12 illustrates an example image processing device 1200. In some embodiments, the image processing device 101 of FIG. 1 comprises the image processing device 1200. The image processing device 1200 of FIG. 12 is a multifunction peripheral having a scanning function in addition to printing, copying and other functions. However, it will be understood that various other implementations of an image processing device are within the scope of the present invention. For example, various components, modules, functions, and/or configurations of the image processing device 1200 of FIG. 12 could be combined, deleted, or modified to form further implementations. Further by way of example, in some embodiments, other devices (for example, a stand-alone scanner, fax machine, or other device with scanning capabilities) and/or computing systems (for example, a computer connected to a scanner) may be implemented as the image processing device 1200.

In some embodiments, the image processing device 1200 performs one or more operations described herein. In some embodiments, the image processing device 1200 provides functionality described herein. In some embodiments, software running on the image processing device 1200 performs one or more operations described herein.

The image processing device 1200 includes one or more processor(s) 1201. The processor(s) 1201 include a central processing unit (CPU) that performs overall control functions for the image processing device 1200. The CPU uses a random access memory (RAM) 1202 as a work area while executing instructions. The CPU executes instructions of various programs stored in one or more memory devices. For example, the CPU executes programs stored in a read only memory (ROM) 1203 and in a storage device 1204.

In some embodiments, the processor(s) 1201 include one or more processors in addition to the CPU. By way of example, the processor(s) 1201 may include one or more general-purpose microprocessor(s), application-specific microprocessor(s), and/or special purpose microprocessor(s). Additionally, in some embodiments the processor(s) 1201 may include one or more internal caches for data or instructions.

The processor(s) 1201 provide the processing capability required to execute an operating system, application programs, and various other functions provided on the image processing device 1200. The processor(s) 1201 perform or cause components of the image processing device 1200 to perform various operations and processes described herein, in accordance with instructions stored in one or more memory devices.

The RAM 1202 is used as a work area when the processor(s) 1201 execute various instructions, such as those making up computer programs stored in the ROM 1203 and/or the storage device 1204. The RAM 1202 may be used as a temporary storage area for various data, including input image data. The RAM 1202 may be used as a cache memory. In some embodiments, the RAM may be dynamic RAM (DRAM) or static RAM (SRAM).

The ROM 1203 stores data and programs having computer-executable instructions for execution by the processor(s) 1201. In some embodiments, the ROM 1203 is a boot ROM, storing instructions for the booting process. In some embodiments, the ROM 1203 may be flash memory.

The storage device 1204 stores application data, program modules and other information. One or more program modules stored in the storage device 1204 are configured to cause various operations and processes described herein to be executed. In some embodiments, the application 103 resides on the storage device 1204 and executes on the image processing device 1200.

The storage device 1204 also stores other programs and data to be processed. For example, the storage device 1204 stores an operating system including programs and data for managing hardware and software components of the image processing device 1200. Applications on the image processing device 1200 may utilize the operating system to perform various operations. The storage device 1204 may further store other programs and/or drivers that enable various functions of the image processing device 1200, graphical user interface (GUI) functions, and/or processor functions. The storage device 1204 may also store data files including, for example, image data, user data, configuration information, GUI components, such as graphical elements or templates, or other data required by the image processing device 1200.

In some embodiments, the image processing device 1200 may include other storage media. By way of example, and not by way of limitation, the storage media may include a floppy disk drive, flash memory, an optical disc, a magneto-optical disc, magnetic tape, or a Universal Serial Bus (USB) drive or a combination of two or more of these. Where appropriate, the storage media may include removable or fixed media. Where appropriate, the storage media may be internal or external to the image processing device 1200. In some embodiments, the storage media is non-volatile, solid-state memory. The storage media may take any suitable physical form. For example, the storage media may be in the form of one or more removable blocks, modules, or chips. The computer-readable storage medium need not be one physical memory device, but can include one or more separate memory devices.

An operation panel interface 1205 provides output signals to and receives input signals from an operation panel 1206. Regarding the output signals, the operation panel interface 1205 provides GUI data to the operation panel 1206 for display on a liquid crystal display (LCD). Regarding the input signals, the operation panel interface 1205 receives input signals based on user input operations at the operation panel 1206 and relays the input signals to the processor(s) 1201. In some embodiments, the operation panel 1206 includes a touch sensitive element operable to receive user input operations or commands based on the touching of graphical objects displayed on the LCD. In some embodiments, the operation panel 1206 includes a hard key panel.

The image processing device 1200 includes one or more input/output (I/O) port(s) 1207. The I/O port(s) 1207 may include any suitable interface type such as a universal serial bus (USB) port, FireWire port (IEEE-1394), serial port, parallel port, or AC/DC power connection port. The I/O port(s) 1207 enable one or more external device(s) 1208 to communicate with the image processing device 1200 when the external device(s) 1208 is/are connected to the I/O port(s) 1207. Examples of external devices 1208 include a near field communication (NFC) interface (for example, an NFC reader), a smart card reader, radio-frequency identification (RFID) reader, device for detecting biometric information, a keyboard, keypad, sensor(s), a combination of two or more of these, or other suitable device.

A network interface 1209 includes hardware, software, or both providing one or more interfaces for communication (such as, for example, packet-based communication) between the image processing device 1200 and one or more other computing systems or one or more networks 1210. As an example and not by way of limitation, the network interface 1209 may include a network interface card (NIC) or a network controller for communicating with an Ethernet or other wire-based network or a wireless NIC (WNIC) or wireless adapter for communicating with a wireless network, such as a WI-FI network. This disclosure contemplates any suitable network 1210 and any suitable network interface 1209 for it. As an example and not by way of limitation, the image processing device 1200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks 1210 may be wired or wireless. As an example, the image processing device 1200 may communicate with a wireless PAN (WPAN) (such as, for example, a BLUETOOTH WPAN), a WI-FI network, a WI-MAX network, or other suitable wireless network or a combination of two or more of these. The image processing device 1200 may include any suitable network interface 1209 for any of these networks 1210, where appropriate.

A modem 1211 modulates/demodulates image data and control signals. The modem 1211 is connected to the Public Switched Telephone Network (PSTN) 1212 and performs input/output of information between the image processing device 1200 and the PSTN 1212. By way of example, the modem 1211 may send/receive facsimile communications.

A system bus 1213 interconnects various components of the image processing device 1200 thereby enabling the transmission of data and execution of various processes. The system bus 1213 may include one or more types of bus structures including a memory bus or memory controller, a peripheral bus, and a local bus using any of a variety of bus architectures.

The device interface 1214 is connected to the scanner unit 1215 and to the printer unit 1216. The device interface 1214 performs synchronous/asynchronous conversion of image data.

The scanner unit 1215 includes a light source and an image sensor. The scanner unit 1215 may include a glass platen and/or an automatic document feeder (ADF). In operation, the light source illuminates a physical document positioned on the glass platen or fed by the ADF. Light reflected by the physical document reaches the image sensor, and the image sensor converts the light into electrical signals. In some embodiments, the scanner unit 1215 includes an optical system (for example, mirrors, lens) that directs the light to the image sensor. After the image sensor generates the electrical signals, an analog-to-digital converter converts the electrical signals to digital image data representing the scanned physical document. The scanner unit 1215 then outputs the digital image data to one or more other components of the image processing device 1200 via the device interface 1214.

The printer unit 1216 is an image output device for printing on a sheet an image corresponding to image data. In response to a print command received at the image processing device 1200, the printer unit 1216 receives image data via the device interface 1214 and outputs to a sheet an image corresponding to the image data.

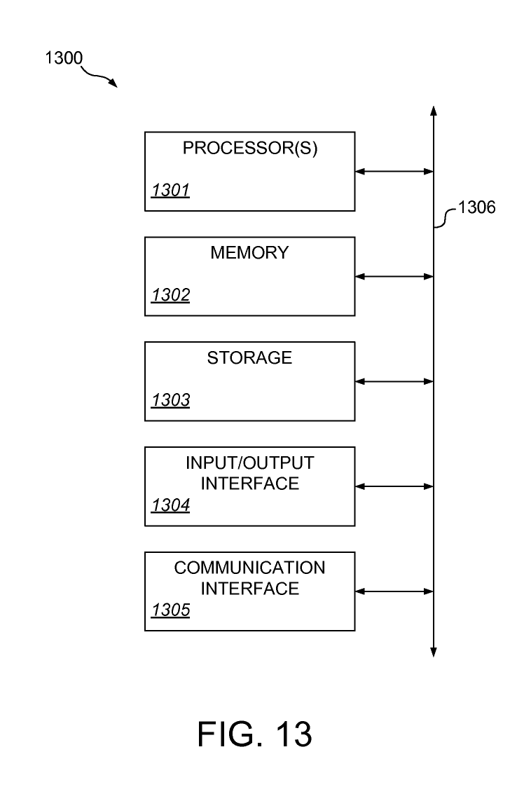

FIG. 13 illustrates an example computing system 1300. According to various embodiments, all or a portion of the description of the computing system 1300 is applicable to all or a portion of one or more of the image processing device 101, the one or more printer(s) 104, the one or more fax machine(s) 105, and the one or more server(s) 106.

The term computing system as used herein includes but is not limited to one or more software modules, one or more hardware modules, one or more firmware modules, or combinations thereof, that work together to perform operations on electronic data. The physical layout of the modules may vary. A computing system may include multiple computing devices coupled via a network. A computing system may include a single computing device where internal modules (such as a memory and processor) work together to perform operations on electronic data. Also, the term resource as used herein includes but is not limited to an object that can be processed at a computing system. A resource can be a portion of executable instructions or data.

In some embodiments, the computing system 1300 performs one or more steps of one or more methods described or illustrated herein. In some embodiments, the computing system 1300 provides functionality described or illustrated herein. In some embodiments, software running on the computing system 1300 performs one or more steps of one or more methods described or illustrated herein or provides functionality described or illustrated herein. Some embodiments include one or more portions of the computing system 1300.

The computing system 1300 includes one or more processor(s) 1301, memory 1302, storage 1303, an input/output (I/O) interface 1304, a communication interface 1305, and a bus 1306. The computing system 1300 may take any suitable physical form. For example, and not by way of limitation, the computing system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, PDA, a server, a tablet computer system, or a combination of two or more of these.

The processor(s) 1301 include hardware for executing instructions, such as those making up a computer program. The processor(s) 1301 may retrieve the instructions from the memory 1302, the storage 1303, an internal register, or an internal cache. The processor(s) 1301 then decode and execute the instructions. Then, the processor(s) 1301 write one or more results to the memory 1302, the storage 1303, the internal register, or the internal cache. The processor(s) 1301 may provide the processing capability to execute the operating system, programs, user and application interfaces, and any other functions of the computing system 1300.

The processor(s) 1301 may include a central processing unit (CPU), one or more general-purpose microprocessor(s), application-specific microprocessor(s), and/or special purpose microprocessor(s), or some combination of such processing components. The processor(s) 1301 may include one or more graphics processors, video processors, audio processors and/or related chip sets.

In some embodiments, the memory 1302 includes main memory for storing instructions for the processor(s) 1301 to execute or data for the processor(s) 1301 to operate on. By way of example, the computing system 1300 may load instructions from the storage 1303 or another source to the memory 1302. During or after execution of the instructions, the processor(s) 1301 may write one or more results (which may be intermediate or final results) to the memory 1302. One or more memory buses (which may each include an address bus and a data bus) may couple the processor(s) 1301 to the memory 1302. One or more memory management units (MMUs) may reside between the processor(s) 1301 and the memory 1302 and facilitate accesses to the memory 1302 requested by the processor(s) 1301. The memory 1302 may include one or more memories. The memory 1302 may be random access memory (RAM).

The storage 1303 stores data and/or instructions. As an example and not by way of limitation, the storage 1303 may include a hard disk drive, a floppy disk drive, flash memory, an optical disc, a magneto-optical disc, magnetic tape, or a Universal Serial Bus (USB) drive or a combination of two or more of these. In some embodiments, the storage 1303 is a removable medium. In some embodiments, the storage 1303 is a fixed medium. In some embodiments, the storage 1303 is internal to the computing system 1300. In some embodiments, the storage 1303 is external to the computing system 1300. In some embodiments, the storage 1303 is non-volatile, solid-state memory. In some embodiments, the storage 1303 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. The storage 1303 may include one or more memory devices. One or more program modules stored in the storage 1303 may be configured to cause various operations and processes described herein to be executed.

The I/O interface 1304 includes hardware, software, or both providing one or more interfaces for communication between the computing system 1300 and one or more I/O devices. The computing system 1300 may include one or more of these I/O devices, where appropriate. One or more of these I/O devices may enable communication between a person and the computing system 1300. As an example and not by way of limitation, an I/O device may include a keyboard, keypad, microphone, monitor, mouse, speaker, still camera, stylus, tablet, touch screen, trackball, video camera, another suitable I/O device or a combination of two or more of these. An I/O device may include one or more sensors. In some embodiments, the I/O interface 1304 includes one or more device or software drivers enabling the processor(s) 1301 to drive one or more of these I/O devices. The I/O interface 1304 may include one or more I/O interfaces.

The communication interface 1305 includes hardware, software, or both providing one or more interfaces for communication (such as, for example, packet-based communication) between the computing system 1300 and one or more other computing systems or one or more networks. As an example and not by way of limitation, the communication interface 1305 may include a network interface card (NIC) or a network controller for communicating with an Ethernet or other wire-based network or a wireless NIC (WNIC) or wireless adapter for communicating with a wireless network, such as a WI-FI network. This disclosure contemplates any suitable network and any suitable communication interface 1305 for it. As an example and not by way of limitation, the computing system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system 1300 may communicate with a wireless PAN (WPAN) (such as, for example, a Bluetooth WPAN or an ultra wideband (UWB) network), a WI-FI network, a WI-MAX network, a cellular telephone network (such as, for example, a Global System for Mobile Communications (GSM) network), or other suitable wireless network or a combination of two or more of these. The computing system 1300 may include any suitable communication interface 1305 for any of these networks, where appropriate. The communication interface 1305 may include one or more communication interfaces 1305.

The bus 1306 interconnects various components of the computing system 1300 thereby enabling the transmission of data and execution of various processes. The bus 1306 may include one or more types of bus structures including a memory bus or memory controller, a peripheral bus, and a local bus using any of a variety of bus architectures.

Various above-described operations performed by the image processing device 101 may be executed and/or controlled by one or more applications running on the image processing device 101. The above description serves to explain principles of the invention; but the invention should not be limited to the examples described above. For example, the order and/or timing of some of the various operations may vary from the examples given above without departing from the scope of the invention. Further by way of example, the type of network and/or computing systems may vary from the examples given above without departing from the scope of the invention. Other variations from the above-recited examples may also exist without departing from the scope of the invention.

The scope of the present invention includes a computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

While the present invention has been described with reference to exemplary embodiments, it is to be understood that the invention is not limited to the disclosed exemplary embodiments.

What is claimed is:

1. A method comprising:
performing, at an image processing device, a login process wherein access to one or more resources on the image processing device is granted based on a credential associated with a user;
receiving, at the image processing device, a request to perform a scan and send process, the request comprising instructions for scanning a physical document and sending an electronic document representing the scanned physical document to a destination;
initiating the scan and send process;
receiving, at the image processing device, a log out command during execution of the scan and send process;
determining that execution of the scan and send process is in progress;
performing a log out process that enables execution of the scan and send process to continue;
storing data associated with the scan and send process in a data structure when execution of the scan and send process has terminated;
receiving, at the image processing device, the credential associated with the user and a request to access one or more resources on the image processing device; and
presenting information about the scan and send process on a display of the image processing device, the information about the scan and send process based on the data associated with the scan and send process in the data structure.

2. The method of claim 1, wherein the information about the scan and send process comprises information indicating whether the electronic document was successfully sent to the destination.

3. The method of claim 1, wherein the data associated with the scan and send process in the data structure includes information that identifies the user.

4. The method of claim 1, further comprising:
determining that information associated with the user matches an entry in the data structure,
wherein the presenting information about the scan and send process on the display of the image processing device is performed in response to the determining that information associated with the user matches an entry in the data structure.

5. The method of claim 1, wherein the information about the scan and send process includes information indicating the scan and send process failed, and
wherein presenting the information about the scan and send process on the display of the image processing device comprises presenting an interface element in a graphical user interface on the display of the image processing device, the interface element enabling a user to issue a command to attempt to resend the electronic document to the destination by selecting the interface element.

6. The method of claim 1, further comprising:
receiving, at the image processing device, a request to perform a second scan and send process;
initiating the second scan and send process while execution of the scan and send process is in progress, wherein the receiving the log out command comprises receiving the log out command during execution of the scan and send process and the second scan and send process, and wherein the performing the log out process comprises performing a log out process that enables execution of the scan and send process to continue and the second scan and send process to continue; and
storing data associated with the second scan and send process in the data structure when execution of the second scan and send process has terminated.

7. The method of claim 6, further comprising:
presenting information about the second scan and send process on the display of the image processing device, the information about the second scan and send process based on the data associated with the second scan and send process in the data structure,
wherein the information about the scan and send process and the information about the second scan and send process are simultaneously presented on the display of the image processing device.

8. The method of claim 1, further comprising:
after performing the log out process that enables execution of the scan and send process to continue, receiving, at the image processing device, a second credential associated with a second user and a request to access one or more resources on the image processing device; and
while execution of the scan and send process is in progress, establishing a login session wherein access to one or more resources on the image processing device is granted based on the second credential associated with the second user, wherein information associated with the scan and send process is not presented on the display of the image processing device during the login session.

9. The method of claim 1, further comprising:
deleting the data associated with the scan and send process from the data structure after presenting the information about the scan and send process on the display of the image processing device.

10. A computer-readable medium storing instructions that, when executed by one or more processors, cause the one or more processors to perform operations comprising:
performing, at an image processing device, a login process wherein access to one or more resources on the image processing device is granted based on a credential associated with a user;
receiving, at the image processing device, a request to perform a scan and send process, the request comprising instructions for scanning a physical document and sending an electronic document representing the scanned physical document to a destination;
initiating the scan and send process;
receiving, at the image processing device, a log out command during execution of the scan and send process;
determining that execution of the scan and send process is in progress;
performing a log out process that enables execution of the scan and send process to continue;
storing data associated with the scan and send process in a data structure when execution of the scan and send process has terminated;
receiving, at the image processing device, the credential associated with the user and a request to access one or more resources on the image processing device; and
presenting information about the scan and send process on a display of the image processing device, the information about the scan and send process based on the data associated with the scan and send process in the data structure.

11. A system comprising:
one or more processors; and
one or more computer-readable media coupled to the one or more processors, the one or more computer-readable media storing instructions that, when executed by the one or more processors, cause the one or more processors to perform operations comprising:
performing, at an image processing device, a login process wherein access to one or more resources on the image processing device is granted based on a credential associated with a user;
receiving, at the image processing device, a request to perform a scan and send process, the request comprising instructions for scanning a physical document and sending an electronic document representing the scanned physical document to a destination;
initiating the scan and send process;
receiving, at the image processing device, a log out command during execution of the scan and send process;
determining that execution of the scan and send process is in progress;
performing a log out process that enables execution of the scan and send process to continue;
storing data associated with the scan and send process in a data structure when execution of the scan and send process has terminated;
receiving, at the image processing device, the credential associated with the user and a request to access one or more resources on the image processing device; and
presenting information about the scan and send process on a display of the image processing device, the information about the scan and send process based on the data associated with the scan and send process in the data structure.

12. The system of claim 11, wherein the information about the scan and send process comprises information indicating whether the electronic document was successfully sent to the destination.

13. The system of claim 11, wherein the data associated with the scan and send process in the data structure includes information that identifies the user.

14. The system of claim 11, the operations further comprising:
determining that information associated with the user matches an entry in the data structure,
wherein the presenting information about the scan and send process on the display of the image processing device is performed in response to the determining that information associated with the user matches an entry in the data structure.

15. The system of claim 11, wherein the information about the scan and send process includes information indicating the scan and send process failed, and
wherein presenting the information about the scan and send process on the display of the image processing device comprises presenting an interface element in a graphical user interface on the display of the image processing device, the interface element enabling a user to issue a command to attempt to resend the electronic document to the destination by selecting the interface element.

16. The system of claim 11, the operations further comprising:
receiving, at the image processing device, a request to perform a second scan and send process;
initiating the second scan and send process while execution of the scan and send process is in progress, wherein the receiving the log out command comprises receiving the log out command during execution of the scan and send process and the second scan and send process, and wherein the performing the log out process comprises performing a log out process that enables execution of the scan and send process to continue and the second scan and send process to continue; and
storing data associated with the second scan and send process in the data structure when execution of the second scan and send process has terminated.

17. The system of claim 16, the operations further comprising:
presenting information about the second scan and send process on the display of the image processing device, the information about the second scan and send process based on the data associated with the second scan and send process in the data structure,
wherein the information about the scan and send process and the information about the second scan and send process are simultaneously presented on the display of the image processing device.

18. The system of claim 11, the operations further comprising:
after performing the log out process that enables execution of the scan and send process to continue, receiving, at the image processing device, a second credential associated with a second user and a request to access one or more resources on the image processing device; and
while execution of the scan and send process is in progress, establishing a login session wherein access to one or more resources on the image processing device is granted based on the second credential associated with the second user, wherein information associated with the scan and send process is not presented on the display of the image processing device during the login session.

19. The system of claim 11, the operations further comprising:
deleting the data associated with the scan and send process from the data structure after presenting the information about the scan and send process on the display of the image processing device.
